(19) United States
(12) Patent Application Publication
(10) Pub. No.: US 2023/0000288 A1
(43) Pub. Date: Jan. 5, 2023

(54) IMPROVED CLOSURE

(71) Applicant: KENWOOD LIMITED, Havant, Hampshire (GB)

(72) Inventor: James SEALY, Havant (GB)

(21) Appl. No.: 17/781,742

(22) PCT Filed: Dec. 4, 2020
(86) PCT No.: PCT/GB2020/053110

§ 371 Date: Jun. 2, 2022

(30) Foreign Application Priority Data
Dec. 5, 2019 (GB) 1917809.4
Dec. 19, 2019 (LU) 101558

(51) Int. Cl. A47J 43/07

(52) U.S. Cl. CPC A47J 43/0722; A47J 2043/0738

(57) ABSTRACT

There is provided a closure for a food processor, wherein the closure comprises a food processing tool.

### INTRODUCTION

The present invention relates to a closure for a food processor. More specifically, the present invention relates to a closure for a food processing container.

### BACKGROUND

Food processors are devices that process food and beverages by heating, cutting, grating, slicing, dicing, mixing, blending, stirring, kneading, cooling, grinding, mincing, crushing, steaming, boiling, infusing, smoking and otherwise physically or chemically converting food from one form into another.

Typically, food processors include a container in which the food is processed with a removably-attachable cover having an aperture formed therein (e.g., a feed-tube) through which food may be inserted into the container for processing. This aperture is typically closed by a closure, either in the form of an externally-fitting cap or an internally-fitting cylinder.

The present invention aims to at least partially ameliorate problems in the prior art.

### SUMMARY OF THE INVENTION

According to the present invention, there is provided a closure for a food processor, wherein the closure comprises a food processing tool. The food processing tool can increase the utility of the closure and the food processor. When, for instance, the cover is attached to the food processor the processing tools typically contained therein (heating/cooling elements, rotary and/or linear cutting tools etc.) are not easily accessible by the user for carrying out small tasks, for example the processing of a single vegetable or fruit. The present invention can therefore provide the user with a separate tool for carrying out such tasks. This is more convenient to the user and requires less space be taken up within their food preparation environment (e.g., kitchen) by tools. Preferably, the food processor is suitable for use in (at least) a first food processing operation and the food processing tool is suitable in a second food processing operation; more preferably the first food processing operation and the second food processing operation are different operations. The food processing tool is preferably a handheld tool. A closure preferably connotes a member for closing a container of a food processor, more preferably a member for closing an opening in a lid of container of a food processor, such as a pusher for a feed tube.

The closure is preferably configured to push food material through a feed tube of the food processor. To this end, the closure may be configured such that the first end of the closure and at least a portion of the closure's food processing tool may be inserted into the feed tube of the food processor. Preferably, the food processing tool is not a pusher—that is, the closure acts as a pusher whereas the food processing tool is suitable for a different food processing operation.

The closure may be configured such that in use it reduces movement of the food within the feed tube. For example, a first end of the closure may be configured to grip food. To this end, the first end of the closure may be non-planar, preferably comprising at least one protrusion which will push at least on to (and preferably into) the food as it is being pushed through the feed tube, thereby assisting in pushing food material through the feed tube. The first end preferably comprises a plurality of protrusions, which are preferably sharp.

The closure may be shaped to interact with at least one complimentary feature of the feed tube and or food processor—for example, the first end of the closure may be shaped to fit between complimentary features of the feed tube, such as blades within the feed tube.

The food processing tool is preferably configured to process food. Processing food preferably comprises converting food from one form into another. The conversion of food from one form into another may be a physical or chemical conversion.

The closure is preferably configured to process food itself using the food processing tool.

In other words, the closure is preferably configured to process food using the food processing tool without a further feature of the food processor.

The food processing tool is optionally configured to process food itself. In other words, the food processing tool is optionally configured to process food without a further feature of the closure or food processor.

The closure is preferably configured to cooperate with at least one further feature of the food processor to process food in cooperation with the at least one further feature, for example by pushing food material through the feed tube of the food processor into engagement with a further feature of the food processor.

The food processing tool is preferably configured to process food in a different way to the way in which the closure is configured to process food in cooperation with the food processor. The food processing tool is preferably configured to provide a first food processing function. The closure is preferably further configured to cooperate with at least one further feature of the food processor to provide at least a second food processing function.

The food processing tool preferably comprises at least one of a potato-peeler, a knife, a slicer, a julienne-cutter, a green been slicer, a carrot-end cutter, a potato-eye remover, a green leaf remover, a bottle-opener, scissors, a cork-screw, pliers, a toothed blade/saw, a pizza-slicer, a file, a spiraliser, a garlic press, nut-crackers, a screw-driver, and a coring-tool.

The closure is preferably configured such that the user can grip the closure to use the food processing tool to process food.

The closure preferably comprises a substantially elliptical cylindrical surface, and the closure's food processing tool is located at or near a line collinear with an element of the surface that passes through the elliptical plane curve at one end of its major axis, or at least located nearer to a line collinear with an element of the surface that passes through the plane curve at one end of the major axis of the ellipse than a line collinear with an element of the surface that passes through the plane curve at one end of the minor axis of the ellipse.

The closure preferably comprises a first end and a second end and a longitudinal axis therebetween.

The food processing tool is preferably located on the side of the closure. The side of the closure preferably extends between the first and second ends of the closure.

By providing a food processing tool located on the side of the closure the food processing tool can increase the utility of the closure and the food processing tool. It can achieve this without changing the way in which the closure cooperates with at least one further feature of the food processor to process food in cooperation with the at least one further feature

The first end of the closure is preferably configured to be inserted into and pass through at least a portion of the feed tube. The first end of the closure is preferably configured to push food material through a feed tube of the food processor. The first end of the closure is preferably the portion of the closure configured to be inserted into and pass through at least a portion of the feed tube before any other portion of the closure. The first end of the closure is preferably a closed end configured to be inserted into the feed tube of the food processor to push food material through the feed tube. The closure is preferably elongate with the first and second ends of the closure being those portions of the closure at the first and second longitudinal ends of the closure. The first end of the closure is preferably configured to pass through at least a portion of the feed tube along a given direction, wherein the given direction is parallel to an axis extending between the first and second ends of the closure.

The closure preferably comprises a first end and a second end, and the food processing tool is located between the first end of the closure and the second end of the closure.

By providing a food processing tool located between the first end of the closure and the second end of the closure the food processing tool can increase the utility of the closure and the food processing tool. It can achieve this without changing the way in which the closure cooperates with at least one further feature of the food processor to process food in cooperation with the at least one further feature.

The closure's food processing tool may be located away from the first end of the closure. By providing a food processing tool away from the first end of the closure the food processing tool can increase the utility of the closure and the food processing tool. It can achieve this without changing the way in which the closure cooperates with at least one further feature of the food processor to process food in cooperation with the at least one further feature.

The closure's food processing tool may be located away from the second end of the closure. By providing a food processing tool away from the first end of the closure the food processing tool can increase the utility of the closure and the food processing tool. It can achieve this without changing the way in which a user handles the closure when inserting the closure into the feed tube of the food processor.

The food processing tool preferably comprises at least one sharp formation. The at least one sharp formation preferably comprises at least one sharp edge. The at least one sharp edge is preferably a blade. The sharp formation may be suitable for milling, grinding, grating, shredding or otherwise cutting food.

For example, an exemplary food processing tool may comprise at least one blade. The edge of each blade may extend between the first and second ends of the closure. For example, the edge of each blade may extend in the same plane as (e.g., parallel to) an axis that passes through the centres of the first and second ends of the closure. Preferably, the closure is configured to pass through at least a portion of the feed tube in a given direction and the blade extends in the same plane as (e.g., parallel to) the given direction.

The food processing tool is preferably releasably coupled to the remainder of the closure. A releasably coupled food processing tool may, for example, be operable to process food without the remainder of the closure. This can provide for different types of food processing tools to be attached to the remainder of the closure, thereby further increasing the utility of the closure. For example, a releasably coupled food processing tool may comprise a handle and a food processing element. Further, this can aid in cleaning of the closure and the food processing tool. Alternatively, the food processing tool may be fixed to or integral with the closure. In which case, the closure's food processing tool is not releasable from the remainder of the closure during normal use. For example, a portion of the closure such as a side extending between the first and second ends of the closure may comprise grating, cutting, or slicing edges formed therein. A fixed coupling can increase the potential utility of the closure and the food processor without substantially increasing the cost or reducing the durability of the closure.

The food processing tool is preferably coupled to the remainder of the closure but moveable relative to the closure. The food processing tool is preferably rotatably coupled to the remainder of the closure. Alternatively, the food processing tool may be fixed in position.

When the closure's food processing tool is coupled to the remainder of the closure but moveable relative to the closure, the closure's food processing tool may move from a first position relative to the remainder of the closure to at least one further position relative to the remainder of the closure. To this end, the food processing tool may be coupled to the remainder of the closure by a moveable coupling, such as an axle. When a closure's food processing tool is in the first position, the first end of the closure and at least a portion (and preferably the whole) of the closure's food processing tool may be inserted into the feed tube of the food processor to push food material through the feed tube of the food processor. Preferably, when the closure's food processing tool is in any of the at least one further positions relative to the remainder of the closure, the first end of the closure and at least a portion (and preferably the whole) of the closure's food processing tool can be inserted into the feed tube of the food processor to push food material through the feed tube of the food processor. In this way, a food processing tool can be positioned in a number of positions when in use, which can increase the utility of the tool, but in each of those positions the tool will not obstruct the insertion of the closure into the feed tube of the food processor.

The food processing tool is preferably releasably held in a position (e.g., the first position) such that the position of the food processing tool relative to the remainder of the closure will not change due to the force of gravity when the orientation of the closure is changed. The closure may comprise a frictional element for that purpose.

The closure may comprise a position selector configured to allow a user to move the tool to a desired position relative to the remainder of the closure and hold the tool at that position. The position selector preferably retains the food processing tool in at least one position relative to the remainder of the closure. For example, a closure may comprise a rotatable food processing tool and an orientation selector configured to allow a user to rotate the food processing tool to a desired orientation relative to the remainder of the closure and hold the tool at that orientation. If the position selector only allows a user to change the orientation of the food processing tool, the position selector may be referred to as an orientation selector. The position selector (orientation selector) may comprise a ratchet mechanism, a releasable block, or a frictional element requiring a predetermined force to overcome, the predetermined force preferably being in excess of that applied by gravity to the tool.

The food processing tool is preferably releasably coupled to the remainder of the closure but moveable relative to the closure. Alternatively, the food processing tool may not be releasably coupled to the remainder of the closure.

The closure preferably comprises a plurality of food processing tools. The plurality of food processing tools is preferably coupled to the remainder of the closure at different positions—for example, on different sides of the closure, or at different points along its longitudinal axis. Each food processing tool is preferably configured to process food differently, which can further increase the utility of the closure and the food processor.

The closure preferably further comprises a coupling device, wherein the coupling device couples at least two food processing tools to the remainder of the closure. The coupling device is preferably releasably coupled to the remainder of the closure. Alternatively, the coupling device may be fixed to or integral with the remainder of the closure. The coupling device is preferably coupled to the remainder of the closure but moveable relative to the remainder of the closure—for example, rotatably coupled to the remainder of the closure. For example, the tool may comprise a carriage, the carriage comprising two or more food processing tools mounted thereon, preferably bladed tools, wherein the carriage is preferably a rotatable carriage. Alternatively, the coupling device may be fixed in position. The closure preferably further comprises a position selector configured to allow a user to move the coupling device to a desired position relative to the remainder of the closure and retain the coupling device at that position. The coupling device is preferably releasably held in a position such that the position of the food processing tool relative to the remainder of the closure will not change due to the force of gravity when the orientation of the closure is changed.

The food processing tools are preferably selectable. The food processing tools are preferably selectable by movement of a coupling device by which the food processing tools are coupled to the remainder of the closure. Alternatively, the food processing tools are selectable by virtue of the tools being coupled to the remainder of the closure at different positions.

The closure preferably comprises a protective element, to reduce the risk of an injury being caused by the food processing tool. For example, the closure may comprise a protective screen partially surrounding the food processing tool.

The closure is preferably configured to selectively cover the food processing tool. The closure preferably comprises a cover for selectively covering the food processing tool. To this end, the closure may comprise a moveable shutter moveable to surround at least a portion of the tool. For example, when the closure comprises a protective screen partially surrounding the tool, the closure may further comprise a movable shutter configured to be moveable to surround a part of the tool not surrounded by the screen.

The closure preferably further comprises a container for collecting food processed using the closure's food processing tool, such as grated, sliced, or peeled food. By providing a container, the utility of the closure and the food processor can be further increased. The closure's container may collect the food as it is processed. For example, the closure may comprise a surface comprising a food processing tool. The surface may extend between the first and second ends of the closure. The closure's food processing tool may be fixed relative to or moveably coupled to the surface. When food is processed by the food processing tool, it is released from the food processing tool on one side of the surface. That side of the surface may be at least partially enclosed, thereby providing a container that collects food as it is processed by the food processing tool. The closure's container has an opening from which the food collected in the closure's container may be removed. The opening in the closure's container may be covered by an openable cover, such as an openable lid or base. In embodiments where the opening in the closure's container is covered by an openable cover, the container may substantially contain the collected food until the openable cover is opened.

The closure is preferably configured to prevent food being processed by the food processor from coming into contact with the closure's food processing tool when the closure is inserted into the feed tube of the food processor. For example, the closure may be configured to close the feed tube of the food processor in such a way as to prevent food material being processed entering the space within the feed tube in which the closure's food processing tool is located. In this regard, the food processing tool preferably does not extend beyond outer edges of the closure and/or preferably does not extend into a container of the food processor.

The closure is preferably configured to prevent one of the feed tube of the food processor and the food processing tool from damaging the other of the feed tube of the food processor and the food processing tool.

The closure is preferably configured to pass through at least a portion of the feed tube in a given direction, and the closure is preferably further configured such that any line parallel to the given direction passing through a point on a boundary of a cross section of the closure defined by the food processing tool also passes through or within a boundary of a cross section of the closure defined by a portion of the closure other than the food processing tool. The portion of the closure other than the food processing tool is preferably a flange. By way of explanation, any cross section of a closure would comprise a boundary. The boundary is the intersection of the cross section's cutting plane with the outer surface of the closure. For example, a cross section of a right circular cylindrical closure may comprise a substantially elliptical region with a flat end if the cross section's cutting plane intersects both the side and end of the cylinder. The elliptical portion of the boundary of the cross section would be defined by the sides of the cylinder and the flat portion of the boundary of the cross section would be defined by the end of the cylinder. In other words, the closure preferably further configured such that each line that is parallel to the given direction and intersects the food processing tool also intersects the closure at another point. The other points are preferably closer to the first (insertion) end of the closure than the food processing tool, preferably at a flange closer to the first end of the closure than the food processing tool. In a preferred embodiment, each line that is parallel to the given direction and intersects the food processing tool also intersects the closure at a point closer to the first end of the closure than the food processing tool and a point closer to the second end of the closure than the food processing tool, preferably at flanges.

The food processing tool is preferably within the footprint of the remainder of the closure. In other words, in an orthographic projection of the closure with projection rays parallel to the given direction, the footprint of the food processing tool is within the footprint of the remainder of the closure. Optionally, such that in use the tool is spaced away from the side of the feed tube.

The feed-tube and the closure preferably comprise one or more guiding elements, preferably rails and/or ribs, configured to be received in one or more corresponding slots in the other of the feed-tube and the closure for guiding the closure along the fee-tube. The first end of the closure may be chamfered or otherwise shaped to guide the closure into the feed tube.

The feed tube or closure is optionally configured to substantially prevent the closure from rotating relative to the feed tube as the closure pushes food material through the feed tube and into the container. For example, at least a portion of the feed tube and closure may be non-circular (e.g., elliptical or square) so as to prevent rotation of the closure relative to the feed tube when the closure is within the feed tube.

The feed tube or closure is optionally configured to substantially prevent the closure from tilting relative to the feed tube as the closure pushes food material through the feed tube. For example, the closure may be shaped to interact with a complimentary feature of the feed tube so as to prevent the closure from tilting relative to the feed tube when the closure is within the feed tube. For example, one of the closure and the feed tube may comprise at least a first protrusion extending along at least a portion of its length and the other of the closure and the feed tube may comprise at least a first recess extending along at least a portion of its length. The protrusion and recess are sized so as to substantially prevent the closure from tilting relative to the feed tube as the closure pushes food material through the feed tube and into the container. The protrusion may be a rib or rail and the corresponding recess may be groove. In one example, the protrusion and recess are sized so as to prevent the closure's food processing tool from touching the inside of the feed tube.

The closure preferably further comprises an aperture therethrough, the aperture being preferably closable by a removable secondary closure. The removable secondary closure is preferably configured in accordance with the closure of any closure described herein. For example, the removable secondary closure may itself comprise a food processing tool, preferably a different tool to the food processing tool of the closure comprising the aperture closable by the removable secondary closure.

The food processing tool is preferably configured to process food by cutting, shredding, grating, slicing, dicing, or mincing the food.

The invention extends to a cover for a container of the food processor, the cover comprising a cover portion, a feed tube and a closure as aforesaid, wherein the closure is adapted to be received by the feed tube.

The invention further extends to a container for the food processor, the container including a cover as aforesaid.

The invention yet further extends to the food processor, including a closure or container as aforesaid.

The closure may be configured to close a feed tube of the food processor.

Whilst the invention has been described in the field of domestic food/drink processing and preparation machines, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances, and any reference to “food”, “Beverage” (or similar language) herein may be replaced by such working mediums.

The invention described here may be implemented in heated and/or cooled machines. It may be used in a machine that is built-in to a work-top or work surface, or in a stand-alone device. The invention can also be provided as a stand-alone device, whether motor-driven or manually powered.

In order that the invention may be more readily understood, reference will now be made to the accompanying drawings, in which:

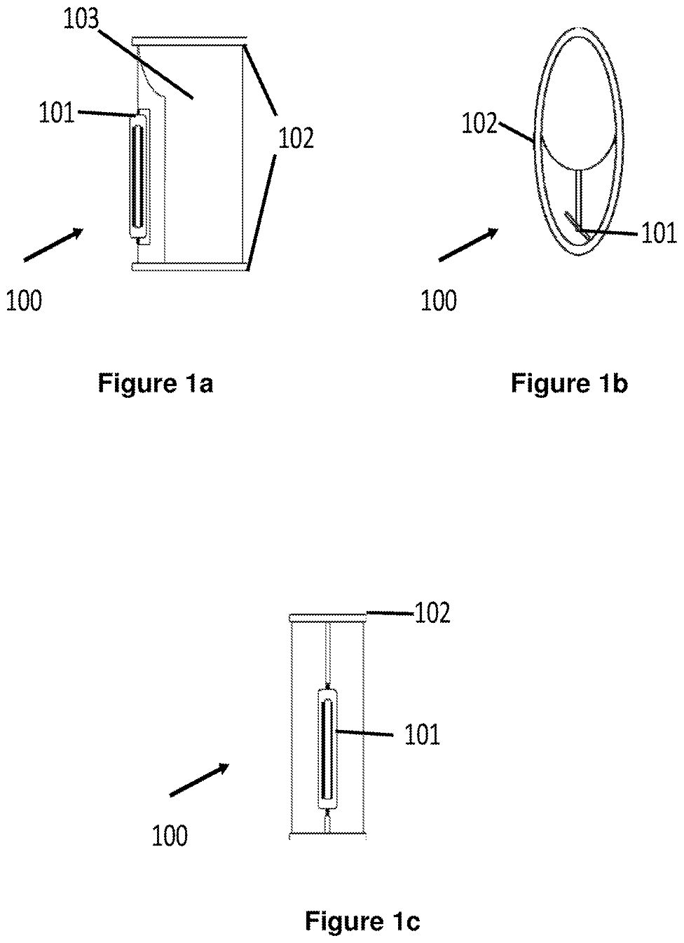

FIG. 1A shows a side-on schematic drawing of a closure according to a first embodiment of the invention;

FIG. 1B shows a top-down schematic view of the closure of FIG. 1A,

FIG. 1C shows a front-on schematic drawing of the closure of FIG. 1A,

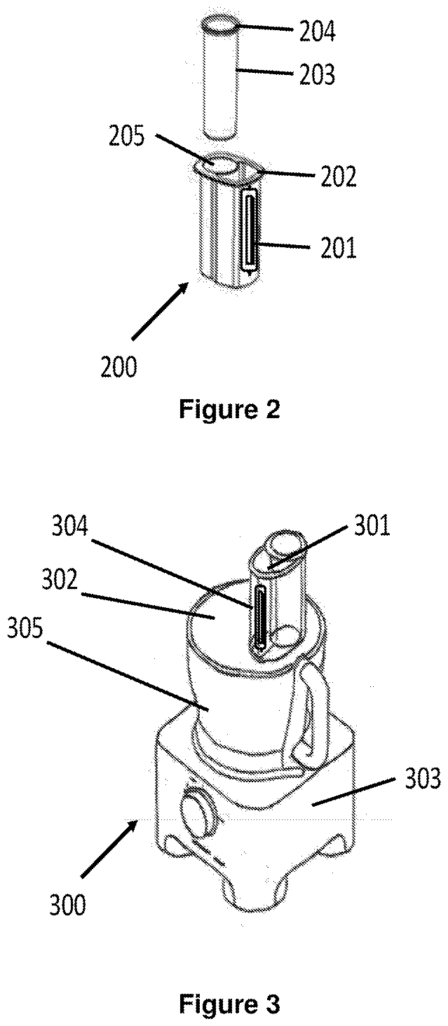

FIG. 2 shows a schematic perspective drawing of a closure according to a second embodiment of the invention;

FIG. 3 shows a perspective drawing of a food processor comprising a closure according to the invention;

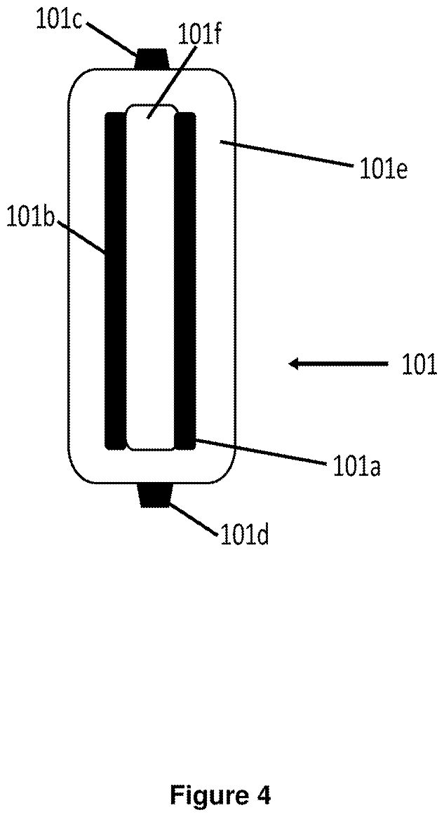

FIG. 4 shows a schematic drawing of a tool of the closure of FIG. 1A;

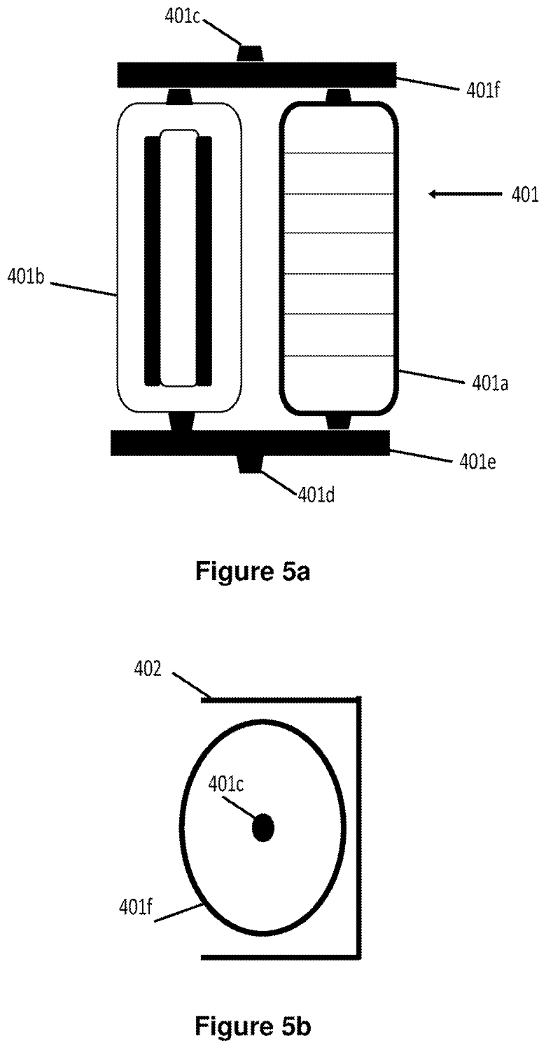

FIG. 5A shows a schematic side-on drawing of an alternative tool for the closure of FIG. 1A;

FIG. 5B shows a top-down schematic drawing of the tool of FIG. 5A; and

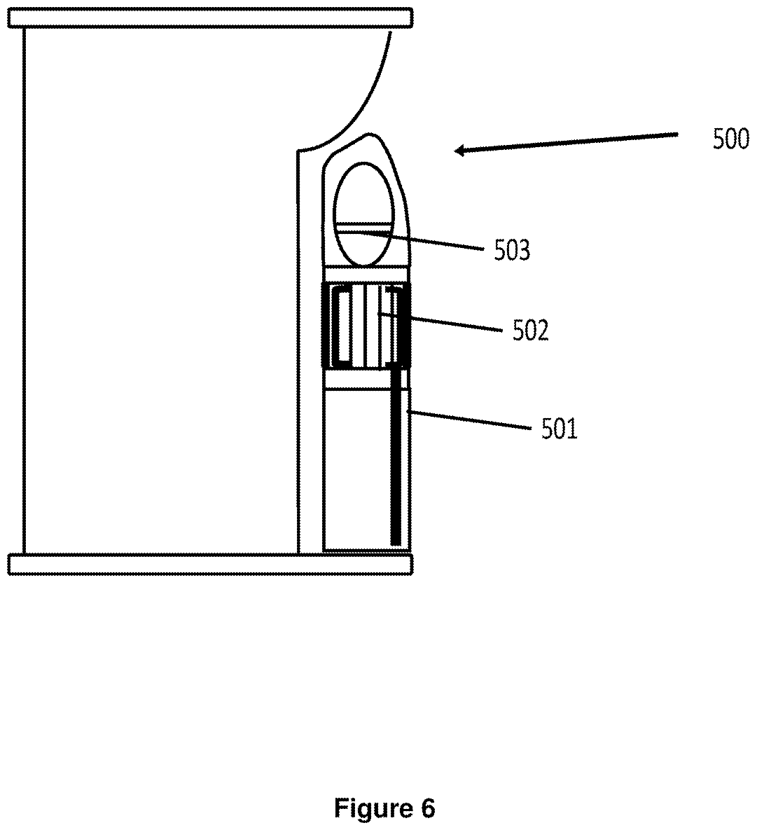

FIG. 6 shows a drawing of a closure according to a third embodiment of the invention.

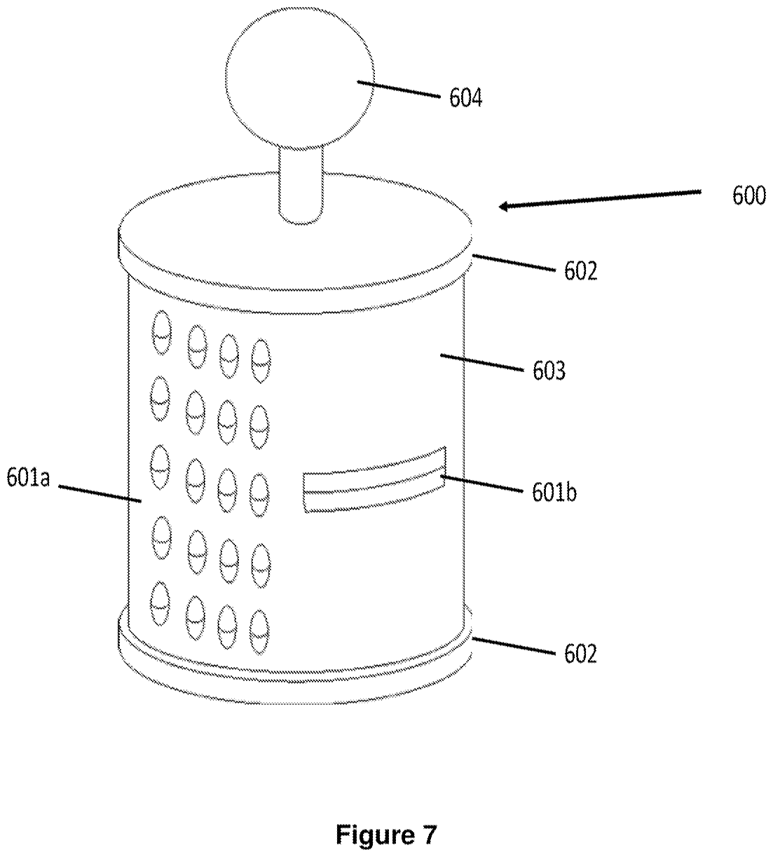

FIG. 7 shows a drawing of a closure according to a fourth embodiment of the invention.

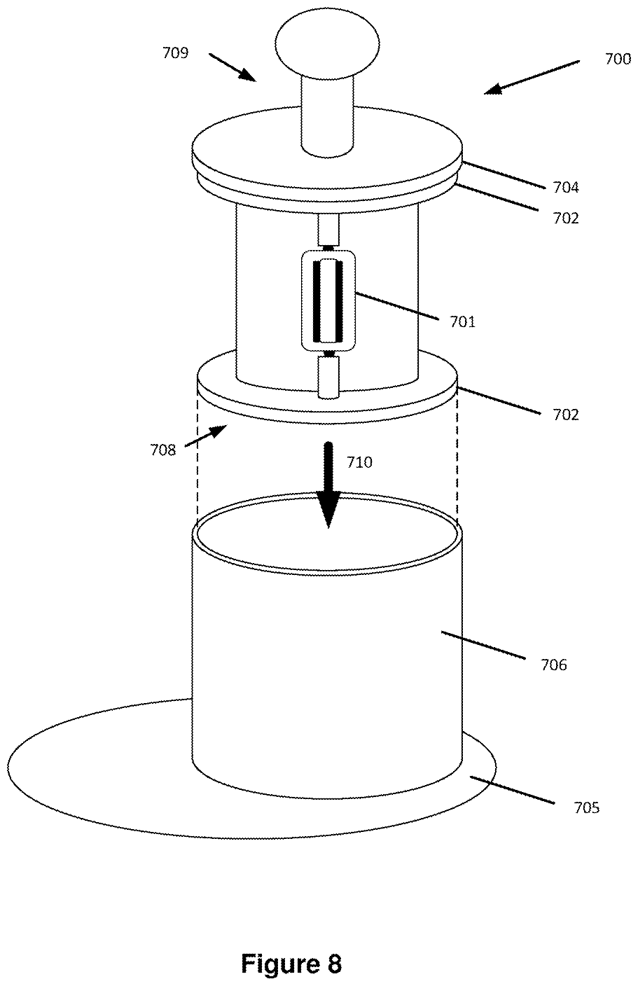

FIG. 8 shows a drawing of a closure and a cover comprising a feed tube according to a fifth embodiment of the invention.

### DETAILED DESCRIPTION

A food processor for use with a closure according to embodiments of the present invention comprises a food processing tool and a container within which food is processed by the food processing tool. The container may comprise a cover that is at least partially releasable from the remainder of the container.

The food processor further comprises a feed tube through which food may be inserted into the container for processing by the food processing tool. The feed tube may comprise an open cylindrical tube—for example, an open elliptical cylinder. In embodiments where the container comprises a cover, the feed tube may be connected to or form part of the cover. For example, FIG. 8 illustrates a cover comprising a cover portion 705 and a feed tube 706.

The food processor further comprises a closure such as any of the closures described herein.

In use, the closure is configured to push food material in the feed tube of the food processor through the feed tube and into the container for processing by the food processing tool. For example, the closure may comprise a first end and a second end and a longitudinal axis therebetween. The first end of the closure may be configured to be inserted into and pass through at least a portion of the feed tube. As shown in FIG. 8, closure 700 comprises a first end 708 and a second end 709. Closure 700 is configured to pass through at least a portion of the feed tube 706 in direction 710.

The closure may be configured to close the feed tube of the food processor. The point at which the feed tube is closed by the closure may change dependent on the position of the closure within the feed tube. By closing the feed tube at a point along the feed tube, the closure prevents food that is being pushed into or processed by the food processor from returning up the feed tube past that point. For example, the closure may comprise a portion at or near its first end dimensioned to prevent food that is being pushed into or processed by the food processor from passing that portion of the closure within the feed tube. For example, the closure may comprise a projection or a flange at or near a first end of the closure. The closure may be dimensioned to substantially fill the feed-tube. The closure 700 illustrated in FIG. 8 comprises a flange 702 at the first end of the closure which fits within and closes feed tube 706, thereby preventing food that is being pushed into or processed by the food processor from passing that portion of the closure within the feed tube.

The closure or the feed tube may be configured to prevent the feed tube from being damaged by the food processing tool (or the food processing tool being damaged by the feed tube). For example, the closure may be configured to limit the distance that the closure may pass through the feed tube of the food processor. To this end, the closure may comprise a stopping element configured to prevent the closure being inserted entirely through the feed tube. For example, the closure may comprise a projection or a flange which prevents the closure being inserted entirely through the feed tube. That projection or flange may be located at or near a second end of the closure. The closure 700 illustrated in FIG. 8 comprises a flange 704 which prevents the closure 700 from being inserted entirely through the feed tube.

FIGS. 1A-1C show a closure 100 according to a first embodiment of the invention. The closure 100 is dimensioned to fit within and close (with flanges 102) the feed-tube of a food processor. The closure 100 preferably has a body which can be gripped in a user's hand. The bottom flange 102 can be used to push food material through the feed tube of a food processor.

In order to increase the utility of the closure 100 and the food processor to which it is connected, the closure comprises a food processing tool. For example, closure 100 has a food processing tool 101 provided on it. The closure's 100 food processing tool 101 is located away from and between the first end of the closure 100 and the second of the closure.

The closure's food processing tool 101 can be fixed in position such that, in particular, the position of the food processing tool relative to the remainder of the closure is fixed.

Alternatively, the food processing tool may be moveably coupled to the remainder of the closure — for example, by a moveable coupling. The food processing tool is more preferably rotatably mounted to allow it to be rotated to a desired orientation—for example, the food processing tool may be attached to a body of the closure by a rotatable coupling, such as an axle, so as to be rotatable relative to the body. The rotatable coupling, such as an axle, may be unlubricated.

As shown in FIG. 1B, the rotation of the tool 101 is preferably such that it cannot be rotated outside the flanges 102 (i.e., it cannot extend beyond their horizontal cross-section as seen in FIG. 1B), to prevent the tool 101 obstructing the insertion of the closure 100 into the feed-tube of a food processor. The lower flange 102 serves to prevent food material being processed entering the space above the flange 102 and e.g., becoming caught on the tool 101.

An exemplary food processing tool 101 is shown in FIG. 4. This food processing tool 101 has two food processing blades 101a and 101b mounted in a frame 101e having a central aperture 101f. As the sharp, cutting edges of the blades 101a and 101b face inwardly towards the central aperture 101f, and as the aperture 101f is preferably dimensioned such that a user's hand or fingers cannot fit within it, the user cannot easily come into contact with the blades 101a and thus the tool 101 is rendered safe. The central aperture 101f is, however, wide enough that fruits and vegetables can be pressed against it and have their surfaces bulge through it to carry out e.g., skinning or peeling.

The tool 101 is preferably mounted to the closure 100 so as to be rotatable about its central axis via axles 101c and 101d. Preferably the axles 101c and 101d include a frictional element such that the user must apply a predetermined amount of force to actually rotate the tool 101, the predetermined amount of force being such that the tool will not change orientation when the closure 100 is tilted or tipped to a different orientation. An example of such a frictional element is a rubber or plastic ring in frictional contact with both the frame 101e and the closure 100. Alternatively a releasable blocking element or ratchet may be provided to selectively hold the tool 101 at a desired orientation relative to the closure 100.

Whilst two blades 101a and 101b are shown, three or more blades may be provided in the tool (e.g., two additional blades may extend along the centre of the aperture 101f with edges facing the blades 101a and 101b).

The axles 101c and 101d may be fixed to the closure 100, or may be removably attachable to it using screw/thread or snap-fittings to allow different tools to be attached to the closure 100.

The tool 101 is preferably aligned along the major axis of the closure 100, such that the user can grip the body of the closure 100 with their hand to use the tool 101 to process food. Closure 100 comprises a substantially elliptical cylindrical surface, and the closure's 100 food processing tool is located at or near a line collinear with an element of the surface that passes through the elliptical plane curve at one end of its major axis.

A second embodiment of a closure 200, similar to the closure 100 except for the following details, is shown in FIG. 2. The closure 200 is dimensioned to fit within and substantially fill the feed-tube of a food processor, it may have vertically-aligned grooves formed along it which receive a corresponding rail/rib extending from the inner surface of the feed-tube to guide the closure 200 along the feed-tube. As with the closure 100, it has a tool 201 mounted rotatably to it, with the rotation of the tool 201 being such that it cannot be rotated to block the passage of the closure down the feed-tube. The closure 200 has a flange 202 formed at its upper end to prevent the closure 200 falling into the food processing container with which the closure 200 is used. The closure 200 additionally has a smaller aperture 205 formed extending through it, which is in turn closed by a secondary closure 203 having an upper flange 204 which prevents the secondary closure 203 falling down the smaller aperture 205 after it is inserted into it.

The purpose of the smaller aperture 205 is to allow smaller pieces of food (e.g., spring onions) to be held oriented vertically for processing within the food processing appliance with which the closure 200 is used. Maintaining a vertical orientation of the food is important during certain food processing techniques, such as, for example, cutting using a rotary blade.

An exemplary food processor 300 featuring a closure 301 according to the invention is shown in FIG. 3. In this arrangement 300 the closure 301 (which is similar to the closures 100 and 200) is located within the feed tube 304 of a cover 302 (preferably, when inserted into the feed-tube 304 the tool of the closure 301 is covered by the feed-tube for added safety). The cover 302 is removably-attachable to a food processing container 305, and serves to substantially co-operatively enclose the volume within the container 305. The container 305 is in turn mounted on, and preferably removably-attached to, the food processor base 303. The base 303 can include an electric motor for providing mechanical power to food processing tools within the container 305, heating/cooling elements for heating/cooling the container 305, and electrical power connectors for providing electrical power to food processing tools within the food processing container 305 (e.g., heating elements). A user interface is provided on the base 303 for controlling the appliance and providing feedback to the user.

A coupling device coupling a plurality of food processing tools 401a and 401b to a closure, which can be used in place of any of the tools described above, is shown in FIGS. 5a and 5b. Rather than consisting of a single food processing tool, two or more food processing tools 401a and 401b are mounted (preferably rotatably) to a carriage comprising disks 401e and 401f which are rotatable about axles 401c and 401d. In this way, the user may rotate the carriage so as to bring a specific food processing tool forward and to recess the other device close to the body of the closure 100, 200, 301. In this way, if the user wishes to use the bean-peeler 401a (a food processing tool having multiple blades with their cutting-edges oriented horizontally towards the viewer as seen in FIG. 4, a bean may then be inserted between the blades and peeled between them) they can rotate the disks 401e and 401f to bring the bean-peeler 401a forward and recess the potato-peeler 401b close to the closure with which the tool 401 is used.

The food processing tools 401a and 401b may be partially surrounded by a screen 402 fixed to the closure so that the tools are only accessible about part of the periphery of the disks 401e and 401f. This would help prevent accidental contact between the user and the devices mounted to the carriage which they have not selected to use, but would still allow the desired food processing tool to be accessed at that part of the periphery of the disks 401e and 401f not surrounded by the screen 402. As an additional modification to this screen 402, it may further include a sliding or hinged element that can be closed to completely surround the periphery of the disks 401e and 401f and the devices attached thereto.

As with the axles 101c and 101d, the axles 401c and 401d are preferably releasably-attachable to the closure and have a frictional element or releasable block/ratchet that allows the disks 401e and 401f to be rotated to a desired orientation and held there.

FIG. 6 shows a closure 500 according to another embodiment of the present invention. The closure 500 has a statically-fixed fixture 501 with two food processing tools—a bean-slicer 502 and a guillotine blade 503. The guillotine blade may be static or moveable within its aperture to cut food located in it. The closure 500 thus achieves a static multi-tool device.

Another example of a closure comprising a plurality of food processing tools is illustrated in FIG. 7. The closure 600 comprises a surface 603 (in this case cylindrical) extending between first and second ends. The ends comprise flanges 600. The surface comprises at least one food processing tool. In this case, a first portion of the surface 603 comprises a first food processing tool 601a and a second portion of the surface comprises a second food processing tool 601b. In this case, the first food processing tool 601a comprises a plurality of grating slots and the second food processing tool 601b comprises a slicing slot. The surface may be metallic—for example, stainless steel.

The closure comprises a handle 604 for gripping the closure. The closure comprises a container within which food processed by the closure's food processing tool, as described above. The food within the container may be accessed by removing one or both of the flanges 602 or a portion thereof—for example, the top flange. One or both of the flanges or a portion thereof may be, for example, screw fit to the remainder of the closure. Alternatively, a hole may be provided in a portion of the surface 603 from which food may be removed from the container. The hole may be covered with an at least partially releasable cover.

Another example of a closure is illustrated in FIG. 8. Closure 700 is configured such that any line parallel to the given direction 710 passing through a point on a boundary of a cross section of the closure defined by the food processing tool 701 also passes through or within a boundary of a cross section of the closure defined by flanges 702 and 704. The closure 700 has a flange 702 at the first end of the closure. Flange 702 is located closer to the first end of the closure than the food processing tool 701 and so serves to prevent food material being processed by the food processor entering the space above the flange 702 and e.g., becoming caught on the tool 701 as the closure is used to push food through the feed tube.

The closures 100, 200, 301, 500, 600, 700 described above are preferably made of food-safe and dish-washer-machine-washable (i.e., will not degrade/deteriorate under the temperatures and conditions typical within a household dish-washer) materials. For example the body of the closures 100, 200, 301, 500, 600, 700 can be made of a food-safe and machine-washable plastic such as a co-polymer such as co-polyester. Suitable materials include Styrene-acrylonitrile resin (SAN) and Tritan™m. Preferably the plastic used is BPA free. Preferably the material used for the closure is substantially transparent so that the user can easily observe the position of any tool and view inside any aperture within the closure.

Preferably the tools 101, 201, 401a and 401b, 501, 601a, 601b, 701 are made of relatively durable, strong, food-safe and machine-washable metals such as stainless steel. The axles 101c, 101d, 401c and 401d are preferably not lubricated with any oil that may be dispersed/dried out by machine-washing, and more preferably are unlubricated.

Whilst a bean-peeler and a potato-peeler have been used above as examples of potential tools/devices usable in this invention, any other food processing tool that might conceivably be mounted in their place can be used. This includes knives, slicers, julienne-cutters, green been slicers, carrot-end cutters, potato-eye removers, green leaf removers for kale and chard, bottle-openers, scissors, cork-screws, pliers, toothed blades/saws, pizza-slicers, files, spiralisers, garlic presses, nut-crackers, screw-drivers, coring-tools and other tools.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

By way of example, the following provides a list of aspects of the invention:
1. A closure for a food processing container, the closure comprising a food-processing tool, preferably a bladed food processing tool.
2. The closure of aspect 1, wherein the food-processing tool is removably attached to the closure.
3. The closure of any preceding aspect, wherein the food processing tool is attached to a body of the closure by an axle so as to be rotatable relative to the body.
4. The closure of aspect 3, further comprising orientation-selection means configured to allow a user to rotate the tool to a desired orientation relative to the closure and hold the tool at that orientation.
5. The closure of aspect 4, wherein the orientation-selection means comprises at least one of the following:
   a ratchet mechanism,
   a releasable block
   a frictional element requiring a predetermined force to overcome, the predetermined force preferably being in excess of that applied by gravity to the tool.

6. The closure of any one of aspects 3-5, wherein the body is dimensioned for hand-gripping.

7. The closure of any preceding aspect, wherein the tool comprises a carriage, the carriage comprising two or more devices mounted thereon, preferably bladed devices, wherein the carriage is preferably a rotatable carriage.

8. The closure of any preceding aspect, wherein the food processing tool comprises a bladed tool.

9. The closure of any preceding aspect, wherein the closure comprises a protective screen partially surrounding the tool.

10. The closure of aspect 8, wherein the closure further comprises a movable shutter configured to be moveable to surround a part of the tool not surrounded by the screen.

11. The closure of aspect 3 and any one of aspects 4-10 as dependent from aspect 3, wherein the axle is unlubricated.

12. The closure of any preceding aspect, wherein the tool is aligned parallel with a major axis of the closure.

13. The closure of any preceding aspect, wherein the tool extends along a side of the closure.

14. The closure of any preceding aspect, further comprising a flange, wherein tool does not extend beyond a horizontal cross-section of the flange.

15. The closure of any preceding aspect, wherein the tool comprises any one of a potato-peeler, a knife, a slicer, a julienne-cutter, a green been slicer, a carrot-end cutter, a potato-eye remover, a green leaf remover, a bottle-opener, scissors, a cork-screw, pliers, a toothed blade/saw, a pizza-slicer, a file, a spiraliser, a garlic press, nut-crackers, a screw-driver, and a coring-tool.

16. The closure of any preceding aspect, wherein the tool comprises a durable, food-safe, dish-washer machine-washable metal, and preferably comprises stainless steel.

17. The closure of any preceding aspect, wherein the closure preferably comprises a food-safe, dish-washer-machine-washable plastic, preferable a co-polymer, more preferably SAN or Tritantm.

18. The closure of any preceding aspect, wherein the closure further defines an aperture therethrough, the aperture being preferably closable by a removable secondary closure.

19. A cover for a container, the container comprising a feed-tube, further comprising the closure of any preceding aspect.

20. The cover of aspect 19, wherein the closure is dimensioned to substantially fill the feed-tube.

21. The cover of any one of aspects 19-20, wherein the closure is configured to act as a pusher for food within the feed-tube.

22. The cover of any one of aspects 19-21, the closure further comprising a stopping-element configured to prevent the closure being inserted entirely through the feed-tube.

23. The cover of any one of aspects 19-22, wherein one of the feed-tube and the closure comprises one or more guiding elements, preferably rails and/or ribs, configured to be received in one or more corresponding slots in the other of the feed-tube and the closure for guiding the closure along the fee-tube.

24. A food processing container comprising the cover of any one of aspects 19-23.

25. A food processor comprising the food processing container of aspect 24.

1-25. (canceled)

26. A closure for a food processor, wherein the closure comprises a food processing tool.

27. A closure according to claim 26, wherein the closure is configured to push food material through a feed tube of the food processor.

28. A closure according to claim 26, wherein the food processing tool is configured to process food.

29. The closure of claim 26, wherein the closure is configured such that the user can grip the closure to use the food processing tool to process food.

30. The closure according to claim 26, wherein the food processing tool is located on the side of the closure.

31. The closure according to claim 26, wherein the closure comprises a first end and a second end, and the food processing tool is located between the first end of the closure and the second end of the closure.

32. The closure according to claim 26, wherein the food processing tool comprises at least one sharp formation.

33. The closure according to claim 26, wherein the food processing tool is releasably coupled to the remainder of the closure.

34. The closure according to claim 26, wherein the food processing tool is coupled to the remainder of the closure but moveable relative to the closure.

35. The closure according to claim 34, further comprising a position selector configured to allow a user to move the food processing tool to a desired position relative to the remainder of the closure and retain the tool at that position.

36. The closure according to claim 34, wherein the food processing tool is releasably held in a position such that the position of the food processing tool relative to the remainder of the closure will not change due to the force of gravity when the orientation of the closure is changed.

37. The closure according to claim 26, wherein the closure comprises a plurality of food processing tools.

38. The closure according to claim 37, wherein the closure further comprises a coupling device, wherein the coupling device couples at least two food processing tools to the remainder of the closure.

39. The closure according to claim 37, wherein the food processing tools are selectable.

40. The closure of claim 26, wherein the closure comprises a protective element to reduce the risk of an injury being caused by the tool.

41. The closure of claim 26, wherein the closure is configured to selectively cover the tool.

42. The closure of claim 26, wherein the closure further comprises a container for collecting food processed using the closure's food processing tool.

43. The closure of claim 26, wherein the closure is configured to prevent food being processed by the food processor from coming into contact with the closure's food processing tool when the closure is inserted into the feed tube of the food processor.

44. The closure of claim 26, wherein the closure is configured to prevent one of the feed tube of the food processor and the food processing tool from damaging the other of the feed tube of the food processor and the food processing tool.

45. The closure of claim 26, wherein the closure is configured to pass through at least a portion of the feed tube in a given direction, wherein the closure is further configured such that any line parallel to the given direction passing through a point on a boundary of a cross section of the closure defined by the food processing tool also passes through or within a boundary of a cross section of the closure defined by a portion of the closure other than the food processing tool.

46. The closure of claim 26, wherein the closure further comprises an aperture therethrough, the aperture being preferably closable by a removable secondary closure.

47. The closure of claim 26, wherein the food processing tool is configured to process food by cutting, grating, slicing, dicing, or mincing the food.

48. A cover for a container of a food processor, the cover comprising a cover portion, a feed tube and the closure of any preceding claim, wherein the closure is adapted to be received by the feed tube.

49. A food processor including the container of claim 48.
